(19) United States
(12) Patent Application Publication
(10) Pub. No.: US 2026/0313158 A1
(43) Pub. Date: Oct. 8, 2026

(54) TEMPORALLY INTERPOLATED PICTURE PREDICTION USING A FRAME-LEVEL MOTION VECTOR

(71) Applicant: GOOGLE LLC, Mountain View, CA (US)

(72) Inventors: Jingning Han, Santa Clara, CA (US); Yunqing Wang, Palo Alto, CA (US); Yaowu Xu, Saratoga, CA (US)

(21) Appl. No.: 19/490,287

(22) PCT Filed: Jun. 4, 2024
(86) PCT No.: PCT/US2024/032361

§ 371 Date: Dec. 4, 2025

Related U.S. Application Data
(60) Provisional application No. 63/471,328, filed on Jun. 6, 2023.

(51) Int. Cl. H04N 19/577; H04N 19/105; H04N 19/117; H04N 19/139; H04N 19/513; H04N 19/80

(52) U.S. Cl. CPC H04N 19/577; H04N 19/105; H04N 19/117; H04N 19/139; H04N 19/513; H04N 19/80

(57) ABSTRACT

A frame-level motion vector is used for motion compensation prediction of a generated (e.g., temporally interpolated picture) reference frame to improve the prediction quality of the generated reference frame when it is used as a display frame in a direct mode. The reference frame is generated for a current frame encoded to a bitstream using a backward reference frame of the current frame and a forward reference frame of the current frame. A determination is made to use the generated reference frame as a display frame in place of the current frame. Based on the determination, a prediction is generated for the generated reference frame using a frame-level motion vector signaled within the bitstream. A frame reconstruction is produced based on the prediction and output within an output video stream.

### BACKGROUND

Digital video streams may represent video using a sequence of frames or still images. Digital video can be used for various applications including, for example, video conferencing, high-definition video entertainment, video advertisements, or sharing of user-generated videos. A digital video stream can contain a large amount of data and consume a significant amount of computing or communication resources of a computing device for processing, transmission, or storage of the video data. Various approaches have been proposed to reduce the amount of data in video streams, including encoding or decoding techniques.

### SUMMARY

Disclosed herein are, inter alia, systems and techniques for temporally interpolated picture prediction during encoding using a frame-level motion vector.

A method for prediction using a frame-level motion vector according to an implementation of this disclosure comprises: generating, for a current frame encoded to a bitstream, a reference frame using a backward reference frame of the current frame and a forward reference frame of the current frame; determining to use the generated reference frame as a display frame in place of the current frame; generating, based on the determination, a prediction for the generated reference frame using a frame-level motion vector signaled within the bitstream; producing a frame reconstruction based on the prediction; and outputting the frame reconstruction within an output video stream.

In some implementations of the method, generating the reference frame using the backward reference frame and the forward reference frame comprises: using motion vectors of the backward reference frame and of the forward reference frame to generate a motion field for the current frame; using the motion field to fetch reference blocks from the backward reference frame and the forward reference frame; and generating the reference frame using the reference blocks.

In some implementations of the method, generating the reference frame using the reference blocks comprises: interpolating the reference blocks.

In some implementations of the method, determining to use the generated reference frame as a display frame in place of the current frame comprises: determining whether there is a motion mismatch with respect to the generated reference frame based on a signaling of a ZEROMV motion vector for the generated reference frame.

In some implementations of the method, the ZEROMV motion vector is the frame-level motion vector.

In some implementations of the method, generating the prediction for the generated reference frame using the frame-level motion vector signaled within the bitstream comprises: performing additional residual coding against the generated reference frame to prepare content of the generated reference for display within the output video stream.

In some implementations of the method, the additional residual coding includes motion compensation performed against the generated reference frame using the frame-level motion vector.

In some implementations of the method, producing the frame reconstruction based on the prediction comprises: using an interpolation filter to interpolate motion indicated by the frame-level motion vector.

In some implementations of the method, the interpolation filter is based on data signaled within the bitstream according to an encoder search.

A non-transitory computer readable medium having stored thereon an encoded bitstream, wherein the encoded bitstream is configured for decoding by operations for prediction using a frame-level motion vector, the operations comprising: determining to use a generated reference frame associated with a current frame encoded to the encoded bitstream as a display frame in place of the current frame; generating, based on the determination, a prediction for the generated reference frame using the frame-level motion vector; and outputting, within an output video stream, a frame reconstruction produced based on the prediction.

In some implementations of the non-transitory computer readable medium, the operations comprise: generating the generated reference frame using motion vectors of a backward reference frame of the current frame and of a forward reference frame of the current frame.

In some implementations of the non-transitory computer readable medium, determining to use the generated reference frame as a display frame in place of the current frame comprises: determining that the frame-level motion vector is signaled within the encoded bitstream for the generated reference frame.

In some implementations of the non-transitory computer readable medium, generating the prediction for the generated reference frame using the frame-level motion vector comprises: performing motion compensation against the generated reference frame using the frame-level motion vector.

In some implementations of the non-transitory computer readable medium, the operations comprise: producing the frame reconstruction based on the prediction; and using an interpolation filter to prepare the frame reconstruction for output as a final display frame by interpolating motion indicated by the frame-level motion vector.

An apparatus for prediction using a frame-level motion vector comprises: a memory; and a processor configured to execute instructions stored in the memory to: generate a reference frame for a current frame to decode; determine to replace the current frame with the generated reference frame within an output video stream; generate, based on the determination, a prediction for the generated reference frame using a frame-level motion vector; and output, as a display frame within the output video stream, a frame reconstruction produced based on the prediction.

In some implementations of the apparatus, the generated reference frame is generated using a backward reference frame of the current frame and a forward reference frame of the current frame, wherein the backward reference frame, the current frame, and the forward reference frame are signaled within and decoded from an encoded bitstream.

In some implementations of the apparatus, the determination to replace the current frame with the generated reference frame within the output video stream is based on a signaling of the frame-level motion vector within the encoded bitstream.

In some implementations of the apparatus, the prediction is generated based on additional residual coding performed against the generated reference frame.

In some implementations of the apparatus, the additional residual coding includes motion compensation performed using the frame-level motion vector.

In some implementations of the apparatus, the frame reconstruction is produced using an interpolation filter.

These and other aspects of this disclosure are disclosed in the following detailed description of the implementations, the appended claims and the accompanying figures.

### BRIEF DESCRIPTION OF THE DRAWINGS

The description herein makes reference to the accompanying drawings described below, wherein like reference numerals refer to like parts throughout the several views.

FIG. 1 is a schematic of an example of a video encoding and decoding system.

FIG. 2 is a block diagram of an example of a computing device that can implement a transmitting station or a receiving station.

FIG. 3 is a diagram of an example of a video stream to be encoded and decoded.

FIG. 4 is a block diagram of an example of an encoder.

FIG. 5 is a block diagram of an example of a decoder.

FIG. 6 is an illustration of examples of portions of a video frame.

FIG. 7 is an illustration of frames used in connection with temporally interpolated picture video coding.

FIG. 8 is a flowchart diagram of an example of a technique for temporally interpolated picture prediction during encoding using a frame-level motion vector.

FIG. 9 is a flowchart diagram of an example of a technique for temporally interpolated picture prediction during decoding using a frame-level motion vector.

### DETAILED DESCRIPTION

Video compression schemes may include breaking respective images, or frames, of a video stream into smaller portions, such as blocks, and generating an encoded bitstream by using encoding techniques to limit the information included for respective blocks thereof. The bitstream can be decoded to re-create the source frames from the limited information. A video stream can be compressed (i.e., encoded) by a variety of techniques to reduce bandwidth required to transmit or store the video stream. Similarly, a variety of techniques can be used to decompress (i.e., decode) a compressed video stream from a bitstream, to prepare the video stream for viewing or further processing. Compression of the video stream often exploits spatial and temporal correlation of video signals through spatial and/or motion-compensated prediction. Motion-compensated prediction may also be referred to as inter-prediction. Inter-prediction uses one or more motion vectors to generate a block (also called a prediction block) that resembles a current block to be encoded using previously encoded and decoded pixels. By encoding the motion vector(s), and the difference between the two blocks (i.e., a residual), a decoder receiving the encoded signal can reconstruct the current block by generating the prediction block and adding pixels of the prediction block to the decoded residual block.

Each motion vector used to generate a prediction block in the inter-prediction process refers a reference frame (i.e., a frame other than a current frame which includes the block that is under prediction). Reference frames can be located before or after the current frame in the sequence of the video stream and may be frames that are reconstructed before being used as a reference frame. In particular, a reference frame may be a forward reference frame (i.e., a frame used for forward prediction relative to the sequence) or a backward reference frame (i.e., a frame used for backward prediction relative to the sequence). One or more forward and/or backward reference frames can be used to encode or decode a block. In particular, because many conventional video compression and decompression schemes use a pyramid coding structure to achieve high compression efficiencies, many frames are encoded and decoded using bi-directional prediction, such as using a forward reference frame and a backward reference frame. Bi-directional prediction using forward and backward reference frames has been shown to substantially improve the quality of prediction and thus the overall compression performance for the subject video stream.

One recent approach for bi-directional prediction uses a temporally interpolated picture (TIP) reference frame. A TIP reference frame is a generated reference frame which is generated by interpolating reference blocks from a forward reference frame and a backward reference frame (e.g., as the nearest future and past reference frames relative to the current frame). In particular, the coded motion vectors available in the forward and backward reference frames are used to generate a motion field for the current frame, and the motion field is then used to fetch the reference blocks which are used to generate the TIP reference frame. TIP video coding thus refers to an inter-prediction mode whereby a TIP reference frame is used to predict the motion of a current frame. TIP video coding typically involves a relatively small motion vector being applied against the TIP reference frame, which small motion vector is not only cheaper to encode, but also improves prediction detail and quality due to the TIP reference frame leveraging forward and backward reference data. The TIP reference frame is independently generated at each of the encoder and the decoder. In particular, the encoder generates the TIP reference frame using data determined as part of an encoder search process, and the decoder generates the TIP reference frame using bitstream data indicative of that encoder search process. The use of this TIP mode for video coding has shown remarkable coding gain achievements relative to video coding schemes which do not use the TIP mode.

Current approaches for TIP video coding enable a “direct mode” (e.g., a “direct TIP mode”) whereby the TIP reference frame is used directly (i.e., without additional residual coding) as a display frame to include in an output video stream for storage or display. This direct mode has been shown to improve coding gains by saving computational cost otherwise spent on operations including, for example, partitioning or frame header processing. However, there are opportunities to further improve the direct mode. In particular, because the TIP frame in the direct mode is used as the display frame without additional residual coding, they may be an opportunity to improve the prediction quality of the TIP frame. Implementations of this disclosure address problems such as these by using a frame-level motion vector for temporally interpolated picture prediction. In particular, the implementations of this disclosure describe approaches for video coding in which a frame-level motion vector usable to perform motion compensation against a generated (e.g., TIP) reference frame indicated for use in a direct mode is signaled within a bitstream and used to improve the prediction quality of the generated reference frame.

While reference is made herein by example to superblocks, macroblocks, blocks, and the like, as are commonly used in video codecs such as VP9, AV1, and the currently in-development AV2, the implementations of this disclosure may be used with other video coding structures. In one particular but non-limiting example, the implementations of this disclosure may be used with coding tree units (CTUs), coding units (CUs), prediction units (Pus), and the like, as are commonly used in video codecs such as H.265, referred to as High-Efficiency Video Coding, and H.266, referred to as Versatile Video Coding. Accordingly, references herein to particular video coding structures such as superblocks, macroblocks, blocks, and the like shall be regarded as expressions of non-limiting example video coding structures with which the implementations of this disclosure may be used.

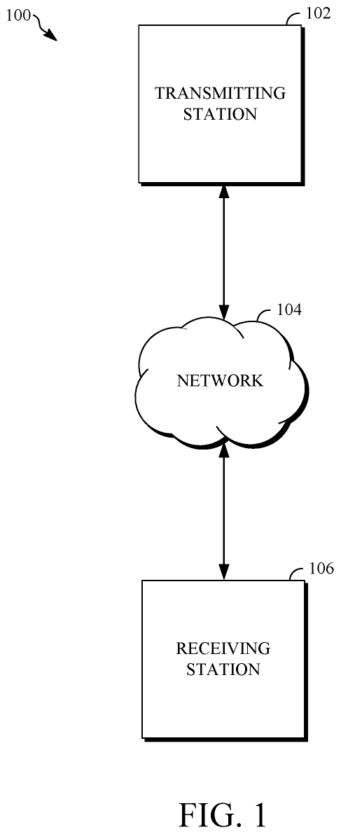

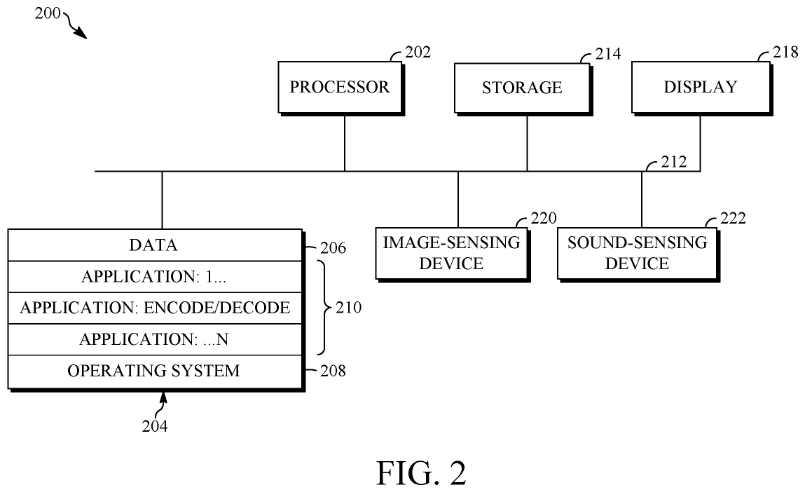

Further details of techniques for temporally interpolated picture prediction using a frame-level motion vector are described herein with initial reference to a system in which such techniques can be implemented. FIG. 1 is a schematic of an example of a video encoding and decoding system 100. A transmitting station 102 can be, for example, a computer having an internal configuration of hardware such as that described in FIG. 2. However, other implementations of the transmitting station 102 are possible. For example, the processing of the transmitting station 102 can be distributed among multiple devices.

A network 104 can connect the transmitting station 102 and a receiving station 106 for encoding and decoding of the video stream. Specifically, the video stream can be encoded in the transmitting station 102, and the encoded video stream can be decoded in the receiving station 106. The network 104 can be, for example, the Internet. The network 104 can also be a local area network (LAN), wide area network (WAN), virtual private network (VPN), cellular telephone network, or any other means of transferring the video stream from the transmitting station 102 to, in this example, the receiving station 106.

The receiving station 106, in one example, can be a computer having an internal configuration of hardware such as that described in FIG. 2. However, other suitable implementations of the receiving station 106 are possible. For example, the processing of the receiving station 106 can be distributed among multiple devices.

Other implementations of the video encoding and decoding system 100 are possible. For example, an implementation can omit the network 104. In another implementation, a video stream can be encoded and then stored for transmission at a later time to the receiving station 106 or any other device having memory. In one implementation, the receiving station 106 receives (e.g., via the network 104, a computer bus, and/or some communication pathway) the encoded video stream and stores the video stream for later decoding. In an example implementation, a real-time transport protocol (RTP) is used for transmission of the encoded video over the network 104. In another implementation, a transport protocol other than RTP may be used, e.g., a video streaming protocol based on the Hypertext Transfer Protocol (HTTP).

When used in a video conferencing system, for example, the transmitting station 102 and/or the receiving station 106 may include the ability to both encode and decode a video stream as described below. For example, the receiving station 106 could be a video conference participant who receives an encoded video bitstream from a video conference server (e.g., the transmitting station 102) to decode and view and further encodes and transmits his or her own video bitstream to the video conference server for decoding and viewing by other participants.

In some implementations, the video encoding and decoding system 100 may instead be used to encode and decode data other than video data. For example, the video encoding and decoding system 100 can be used to process image data. The image data may include a block of data from an image. In such an implementation, the transmitting station 102 may be used to encode the image data and the receiving station 106 may be used to decode the image data.

Alternatively, the receiving station 106 can represent a computing device that stores the encoded image data for later use, such as after receiving the encoded or pre-encoded image data from the transmitting station 102. As a further alternative, the transmitting station 102 can represent a computing device that decodes the image data, such as prior to transmitting the decoded image data to the receiving station 106 for display.

FIG. 2 is a block diagram of an example of a computing device 200 that can implement a transmitting station or a receiving station. For example, the computing device 200 can implement one or both of the transmitting station 102 and the receiving station 106 of FIG. 1. The computing device 200 can be in the form of a computing system including multiple computing devices, or in the form of one computing device, for example, a mobile phone, a tablet computer, a laptop computer, a notebook computer, a desktop computer, and the like.

A processor 202 in the computing device 200 can be a conventional central processing unit. Alternatively, the processor 202 can be another type of device, or multiple devices, capable of manipulating or processing information now existing or hereafter developed. For example, although the disclosed implementations can be practiced with one processor as shown (e.g., the processor 202), advantages in speed and efficiency can be achieved by using more than one processor.

A memory 204 in computing device 200 can be a read only memory (ROM) device or a random access memory (RAM) device in an implementation. However, other suitable types of storage device can be used as the memory 204. The memory 204 can include code and data 206 that is accessed by the processor 202 using a bus 212. The memory 204 can further include an operating system 208 and application programs 210, the application programs 210 including at least one program that permits the processor 202 to perform the techniques described herein. For example, the application programs 210 can include applications 1 through N, which further include encoding and/or decoding software that performs, amongst other things, temporally interpolated picture prediction using a frame-level motion vector as described herein.

The computing device 200 can also include a secondary storage 214, which can, for example, be a memory card used with a mobile computing device. Because the video communication sessions may contain a significant amount of information, they can be stored in whole or in part in the secondary storage 214 and loaded into the memory 204 as needed for processing.

The computing device 200 can also include one or more output devices, such as a display 218. The display 218 may be, in one example, a touch sensitive display that combines a display with a touch sensitive element that is operable to sense touch inputs. The display 218 can be coupled to the processor 202 via the bus 212. Other output devices that permit a user to program or otherwise use the computing device 200 can be provided in addition to or as an alternative to the display 218. When the output device is or includes a display, the display can be implemented in various ways, including by a liquid crystal display (LCD), a cathode-ray tube (CRT) display, or a light emitting diode (LED) display, such as an organic LED (OLED) display.

The computing device 200 can also include or be in communication with an image-sensing device 220, for example, a camera, or any other image-sensing device 220 now existing or hereafter developed that can sense an image such as the image of a user operating the computing device 200. The image-sensing device 220 can be positioned such that it is directed toward the user operating the computing device 200. In an example, the position and optical axis of the image-sensing device 220 can be configured such that the field of vision includes an area that is directly adjacent to the display 218 and from which the display 218 is visible.

The computing device 200 can also include or be in communication with a sound-sensing device 222, for example, a microphone, or any other sound-sensing device now existing or hereafter developed that can sense sounds near the computing device 200. The sound-sensing device 222 can be positioned such that it is directed toward the user operating the computing device 200 and can be configured to receive sounds, for example, speech or other utterances, made by the user while the user operates the computing device 200.

Although FIG. 2 depicts the processor 202 and the memory 204 of the computing device 200 as being integrated into one unit, other configurations can be utilized. The operations of the processor 202 can be distributed across multiple machines (wherein individual machines can have one or more processors) that can be coupled directly or across a local area or other network. The memory 204 can be distributed across multiple machines such as a network-based memory or memory in multiple machines performing the operations of the computing device 200.

Although depicted here as one bus, the bus 212 of the computing device 200 can be composed of multiple buses. Further, the secondary storage 214 can be directly coupled to the other components of the computing device 200 or can be accessed via a network and can comprise an integrated unit such as a memory card or multiple units such as multiple memory cards. The computing device 200 can thus be implemented in a wide variety of configurations.

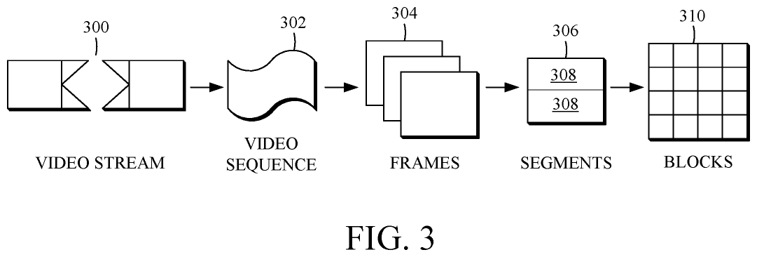

FIG. 3 is a diagram of an example of a video stream 300 to be encoded and decoded. The video stream 300 includes a video sequence 302. At the next level, the video sequence 302 includes a number of adjacent video frames 304. While three frames are depicted as the adjacent frames 304, the video sequence 302 can include any number of adjacent frames 304. The adjacent frames 304 can then be further subdivided into individual video frames, for example, a frame 306.

At the next level, the frame 306 can be divided into a series of planes or segments 308. The segments 308 can be subsets of frames that permit parallel processing, for example. The segments 308 can also be subsets of frames that can separate the video data into separate colors. For example, a frame 306 of color video data can include a luminance plane and two chrominance planes. The segments 308 may be sampled at different resolutions.

Whether or not the frame 306 is divided into segments 308, the frame 306 may be further subdivided into blocks 310, which can contain data corresponding to, for example, N×M pixels in the frame 306, in which N and M may refer to the same integer value or to different integer values. The blocks 310 can also be arranged to include data from one or more segments 308 of pixel data. The blocks 310 can be of any suitable size, such as 4x4 pixels, 8×8 pixels, 16×8 pixels, 8×16 pixels, 16×16 pixels, or larger up to a maximum block size, which may be 128×128 pixels or another N×M pixels size.

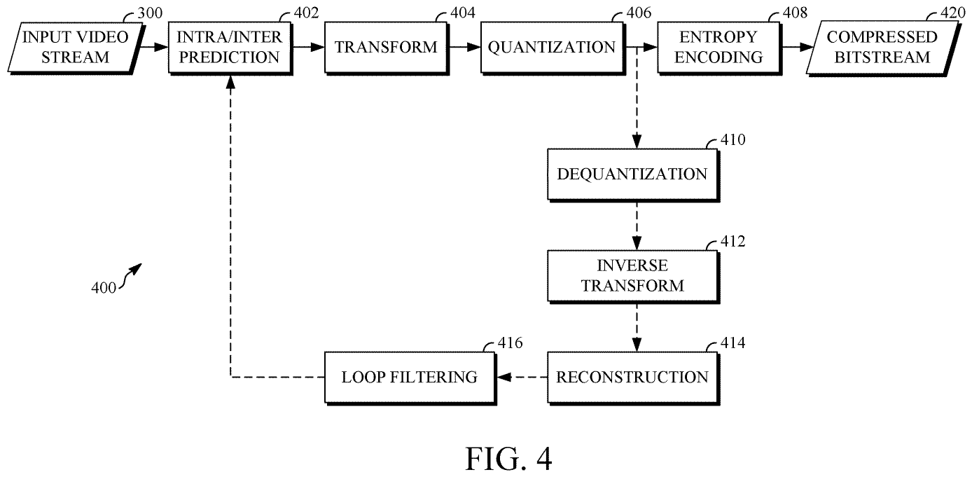

FIG. 4 is a block diagram of an example of an encoder 400. The encoder 400 can be implemented, as described above, in the transmitting station 102, such as by providing a computer software program stored in memory, for example, the memory 204. The computer software program can include machine instructions that, when executed by a processor such as the processor 202, cause the transmitting station 102 to encode video data in the manner described in FIG. 4. The encoder 400 can also be implemented as specialized hardware included in, for example, the transmitting station 102. In some implementations, the encoder 400 is a hardware encoder.

The encoder 400 has the following stages to perform the various functions in a forward path (shown by the solid connection lines) to produce an encoded or compressed bitstream 420 using the video stream 300 as input: an intra/inter prediction stage 402, a transform stage 404, a quantization stage 406, and an entropy encoding stage 408. The encoder 400 may also include a reconstruction path (shown by the dotted connection lines) to reconstruct a frame for encoding of future blocks. In FIG. 4, the encoder 400 has the following stages to perform the various functions in the reconstruction path: a dequantization stage 410, an inverse transform stage 412, a reconstruction stage 414, and a loop filtering stage 416. Other structural variations of the encoder 400 can be used to encode the video stream 300.

In some cases, the functions performed by the encoder 400 may occur after a filtering of the video stream 300. That is, the video stream 300 may undergo pre-processing according to one or more implementations of this disclosure prior to the encoder 400 receiving the video stream 300. Alternatively, the encoder 400 may itself perform such pre-processing against the video stream 300 prior to proceeding to perform the functions described with respect to FIG. 4, such as prior to the processing of the video stream 300 at the intra/inter prediction stage 402.

When the video stream 300 is presented for encoding after the pre-processing is performed, respective adjacent frames 304, such as the frame 306, can be processed in units of blocks. At the intra/inter prediction stage 402, respective blocks can be encoded using intra-frame prediction (also called intra-prediction) or inter-frame prediction (also called inter-prediction). In any case, a prediction block can be formed. In the case of intra-prediction, a prediction block may be formed from samples in the current frame that have been previously encoded and reconstructed. In the case of inter-prediction, a prediction block may be formed from samples in one or more previously constructed reference frames.

Next, the prediction block can be subtracted from the current block at the intra/inter prediction stage 402 to produce a residual block (also called a residual). The transform stage 404 transforms the residual into transform coefficients in, for example, the frequency domain using block-based transforms. The quantization stage 406 converts the transform coefficients into discrete quantum values, which are referred to as quantized transform coefficients, using a quantizer value or a quantization level. For example, the transform coefficients may be divided by the quantizer value and truncated.

The quantized transform coefficients are then entropy encoded by the entropy encoding stage 408. The entropy-encoded coefficients, together with other information used to decode the block (which may include, for example, syntax elements such as used to indicate the type of prediction used, transform type, motion vectors, a quantizer value, or the like), are then output to the compressed bitstream 420. The compressed bitstream 420 can be formatted using various techniques, such as variable length coding or arithmetic coding. The compressed bitstream 420 can also be referred to as an encoded video stream or encoded video bitstream, and the terms will be used interchangeably herein.

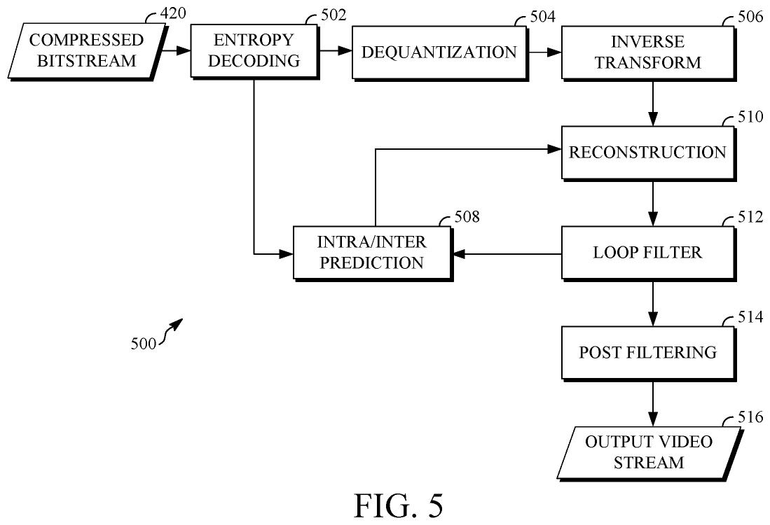

The reconstruction path (shown by the dotted connection lines) can be used to ensure that the encoder 400 and a decoder 500 (described below with respect to FIG. 5) use the same reference frames to decode the compressed bitstream 420. The reconstruction path performs functions that are similar to functions that take place during the decoding process (described below with respect to FIG. 5), including dequantizing the quantized transform coefficients at the dequantization stage 410 and inverse transforming the dequantized transform coefficients at the inverse transform stage 412 to produce a derivative residual block (also called a derivative residual).

At the reconstruction stage 414, the prediction block that was predicted at the intra/inter prediction stage 402 can be added to the derivative residual to create a reconstructed block. The loop filtering stage 416 can apply an in-loop filter or other filter to the reconstructed block to reduce distortion such as blocking artifacts. Examples of filters which may be applied at the loop filtering stage 416 include, without limitation, a deblocking filter, a directional enhancement filter, and a loop restoration filter.

Other variations of the encoder 400 can be used to encode the compressed bitstream 420. In some implementations, a non-transform based encoder can quantize the residual signal directly without the transform stage 404 for certain blocks or frames. In some implementations, an encoder can have the quantization stage 406 and the dequantization stage 410 combined in a common stage.

FIG. 5 is a block diagram of an example of a decoder 500. The decoder 500 can be implemented in the receiving station 106, for example, by providing a computer software program stored in the memory 204. The computer software program can include machine instructions that, when executed by a processor such as the processor 202, cause the receiving station 106 to decode video data in the manner described in FIG. 5. The decoder 500 can also be implemented in hardware included in, for example, the transmitting station 102 or the receiving station 106. In some implementations, the decoder 500 is a hardware decoder.

The decoder 500, similar to the reconstruction path of the encoder 400 discussed above, includes in one example the following stages to perform various functions to produce an output video stream 516 from the compressed bitstream 420: an entropy decoding stage 502, a dequantization stage 504, an inverse transform stage 506, an intra/inter prediction stage 508, a reconstruction stage 510, a loop filtering stage 512, and a post filter stage 514. Other structural variations of the decoder 500 can be used to decode the compressed bitstream 420.

When the compressed bitstream 420 is presented for decoding, the data elements within the compressed bitstream 420 can be decoded by the entropy decoding stage 502 to produce a set of quantized transform coefficients. The dequantization stage 504 dequantizes the quantized transform coefficients (e.g., by multiplying the quantized transform coefficients by the quantizer value), and the inverse transform stage 506 inverse transforms the dequantized transform coefficients to produce a derivative residual that can be identical to that created by the inverse transform stage 412 in the encoder 400. Using header information decoded from the compressed bitstream 420, the decoder 500 can use the intra/inter prediction stage 508 to create the same prediction block as was created in the encoder 400 (e.g., at the intra/inter prediction stage 402).

At the reconstruction stage 510, the prediction block can be added to the derivative residual to create a reconstructed block. The loop filtering stage 512 can be applied to the reconstructed block to reduce blocking artifacts. Examples of filters which may be applied at the loop filtering stage 512 include, without limitation, a deblocking filter, a directional enhancement filter, and a loop restoration filter. Other filtering can be applied to the reconstructed block. In this example, the post filter stage 514 is applied to the reconstructed block to reduce blocking distortion, and the result is output as the output video stream 516. The output video stream 516 can also be referred to as a decoded video stream, and the terms will be used interchangeably herein.

Other variations of the decoder 500 can be used to decode the compressed bitstream 420. In some implementations, the decoder 500 can produce the output video stream 516 without the post filter stage 514 or otherwise omit the post filter stage 514.

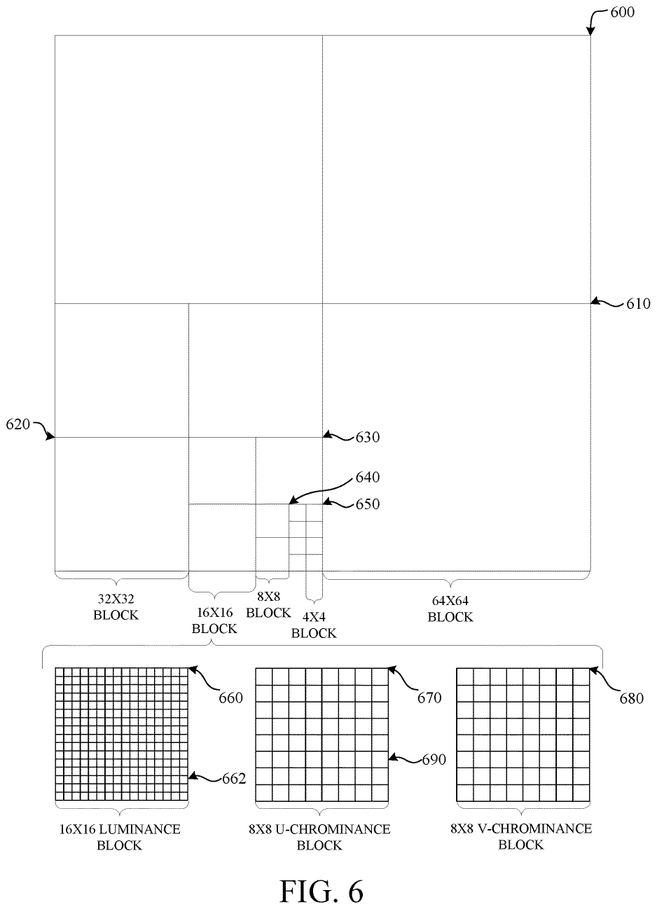

FIG. 6 is an illustration of examples of portions of a video frame 600, which may, for example, be the frame 306 shown in FIG. 3. The video frame 600 includes a number of 64×64 blocks 610, such as four 64×64 blocks 610 in two rows and two columns in a matrix or Cartesian plane, as shown. Each 64×64 block 610 may include up to four 32×32 blocks 620. Each 32×32 block 620 may include up to four 16×16 blocks 630. Each 16×16 block 630 may include up to four 8×8 blocks 640. Each 8×8 block 640 may include up to four 4×4 blocks 950. Each 4×4 block 950 may include 16 pixels, which may be represented in four rows and four columns in each respective block in the Cartesian plane or matrix. In some implementations, the video frame 600 may include blocks larger than 64×64 and/or smaller than 4×4. Subject to features within the video frame 600 and/or other criteria, the video frame 600 may be partitioned into various block arrangements.

The pixels may include information representing an image captured in the video frame 600, such as luminance information, color information, and location information. In some implementations, a block, such as a 16×16 pixel block as shown, may include a luminance block 660, which may include luminance pixels 662; and two chrominance blocks 670, 680, such as a U or Cb chrominance block 670, and a V or Cr chrominance block 680.

The chrominance blocks 670, 680 may include chrominance pixels 690. For example, the luminance block 660 may include 16×16 luminance pixels 662 and each chrominance block 670, 680 may include 8×8 chrominance pixels 690 as shown. Although one arrangement of blocks is shown, any arrangement may be used. Although FIG. 6 shows N×N blocks, in some implementations, N×M blocks may be used, wherein N and M are different numbers. For example, 32×64 blocks, 64×32 blocks, 16×32 blocks, 32×16 blocks, or any other size blocks may be used. In some implementations, N×2N blocks, 2N×N blocks, or a combination thereof, may be used.

In some implementations, coding the video frame 600 may include ordered block-level coding. Ordered block-level coding may include coding blocks of the video frame 600 in an order, such as raster-scan order, wherein blocks may be identified and processed starting with a block in the upper left corner of the video frame 600, or portion of the video frame 600, and proceeding along rows from left to right and from the top row to the bottom row, identifying each block in turn for processing. For example, the 64×64 block in the top row and left column of the video frame 600 may be the first block coded and the 64×64 block immediately to the right of the first block may be the second block coded. The second row from the top may be the second row coded, such that the 64×64 block in the left column of the second row may be coded after the 64×64 block in the rightmost column of the first row.

In some implementations, coding a block of the video frame 600 may include using quad-tree coding, which may include coding smaller block units within a block in raster-scan order. For example, the 64×64 block shown in the bottom left corner of the portion of the video frame 600 may be coded using quad-tree coding wherein the top left 32×32 block may be coded, then the top right 32×32 block may be coded, then the bottom left 32×32 block may be coded, and then the bottom right 32×32 block may be coded. Each 32×32 block may be coded using quad-tree coding wherein the top left 16×16 block may be coded, then the top right 16×16 block may be coded, then the bottom left 16×16 block may be coded, and then the bottom right 16×16 block may be coded. Each 16×16 block may be coded using quad-tree coding wherein the top left 8×8 block may be coded, then the top right 8×8 block may be coded, then the bottom left 8×8 block may be coded, and then the bottom right 8×8 block may be coded. Each 8×8 block may be coded using quad-tree coding wherein the top left 4×4 block may be coded, then the top right 4×4 block may be coded, then the bottom left 4×4 block may be coded, and then the bottom right 4×4 block may be coded. In some implementations, 8×8 blocks may be omitted for a 16×16 block, and the 16×16 block may be coded using quad-tree coding wherein the top left 4×4 block may be coded, then the other 4×4 blocks in the 16×16 block may be coded in raster-scan order.

In some implementations, coding the video frame 600 may include encoding the information included in the original version of the image or video frame by, for example, omitting some of the information from that original version of the image or video frame from a corresponding encoded image or encoded video frame. For example, the coding may include reducing spectral redundancy, reducing spatial redundancy, or a combination thereof. Reducing spectral redundancy may include using a color model based on a luminance component (Y) and two chrominance components (U and V or Cb and Cr), which may be referred to as the YUV or YCbCr color model, or color space. Using the YUV color model may include using a relatively large amount of information to represent the luminance component of a portion of the video frame 600, and using a relatively small amount of information to represent each corresponding chrominance component for the portion of the video frame 600. For example, a portion of the video frame 600 may be represented by a high-resolution luminance component, which may include a 16×16 block of pixels, and by two lower resolution chrominance components, each of which represents the portion of the image as an 8×8 block of pixels. A pixel may indicate a value, for example, a value in the range from 0 to 255, and may be stored or transmitted using, for example, eight bits. Although this disclosure is described in reference to the YUV color model, another color model may be used. Reducing spatial redundancy may include transforming a block into the frequency domain using, for example, a discrete cosine transform. For example, a unit of an encoder may perform a discrete cosine transform using transform coefficient values based on spatial frequency.

Although described herein with reference to matrix or Cartesian representation of the video frame 600 for clarity, the video frame 600 may be stored, transmitted, processed, or a combination thereof, in a data structure such that pixel values may be efficiently represented for the video frame 600. For example, the video frame 600 may be stored, transmitted, processed, or any combination thereof, in a two-dimensional data structure such as a matrix as shown, or in a one-dimensional data structure, such as a vector array. Furthermore, although described herein as showing a chrominance subsampled image where U and V have half the resolution of Y, the video frame 600 may have different configurations for the color channels thereof. For example, referring still to the YUV color space, full resolution may be used for all color channels of the video frame 600. In another example, a color space other than the YUV color space may be used to represent the resolution of color channels of the video frame 600.

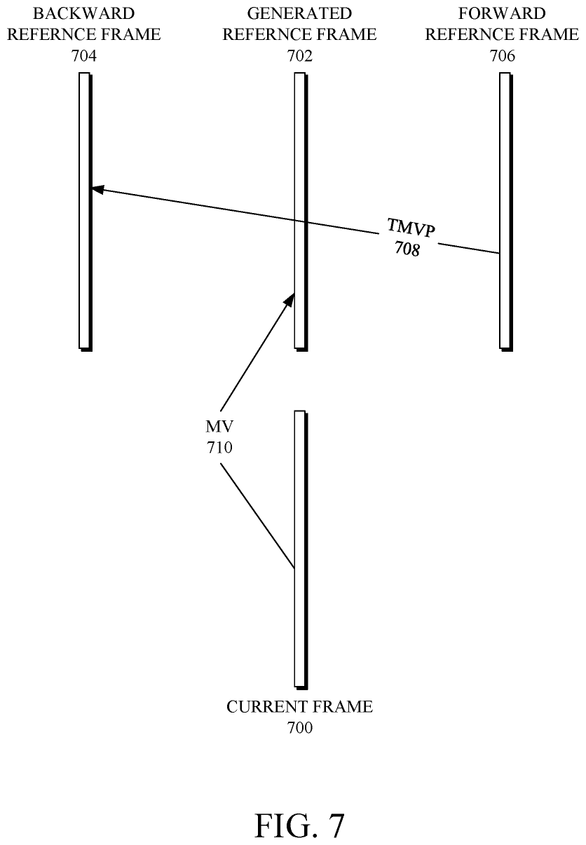

FIG. 7 is an illustration of frames used in connection with TIP video coding. A current frame 700 represents a frame under prediction (e.g., using the TIP mode described herein), for example, during encoding (e.g., at the intra/inter prediction stage 402) or decoding (e.g., at the intra/inter prediction stage 510). A generated reference frame 702, which may, for example, be a TIP reference frame, is generated (e.g., on a streaming basis (i.e., portion by portion)) using a motion field based on a backward reference frame 704 and a forward reference frame 706. For example, where the current frame 700 is denoted as Fᵢ, the backward reference frame 704 can be denoted as Fᵢ₋₁ and the forward reference frame 706 can be denoted at Fᵢ₊₁.

Generally, the backward reference frame 704 and the forward reference frame 706 will be the same distance apart from the current frame 700 in a display order of the video sequence that includes them. However, in some implementations, the backward reference frame 704 and the forward reference frame 706 may be different distances apart from the current frame 700 in the display order. A temporal motion vector predictor 708 represents a motion vector predictor pointing from the backward reference frame 704 to the forward reference frame 706. A motion vector 710 pointing from the current frame 700 to the generated frame 702 represents a motion vector which may be used with the generated frame 702 to predict the motion within one or more blocks of the current frame 700.

In particular, the reference frames 704 and 706 have already been coded by the time they are identified for use as reference frames for the current frame 700. As such, motion vectors of the reference frames 704 and 706 are already known and available, from the earlier coding of the reference frames 704 and 706. Thus, once the reference frames 704 and 706 are identified, a motion field is determined for the current frame 700 using the motion vectors of the reference frames 704 and 706. In particular, the motion field includes motion field motion vectors each pointing to one of the forward reference frame 706 or the backward reference frame 704. The motion field effectively represents how the motion field motion vectors can be projected to determine motion vectors for the current frame 700, since the current frame 700 is in between the backward reference frame 704 and the forward reference frame 706. In some cases, a compound motion vector derivation approach may be used.

The motion field determined for the current frame 700 using the motion vectors of the backward reference frame 704 and the forward reference frame 706 has a same size as the current frame 700. The motion field for the current frame 700 may be separately determined at each of an encoder and a decoder to reduce bitstream size otherwise used for signaling the motion field. Once the motion field has been determined, the motion field motion vectors of the motion field can be stored for later use. For example, the motion field motion vectors may be stored in a memory buffer or cache.

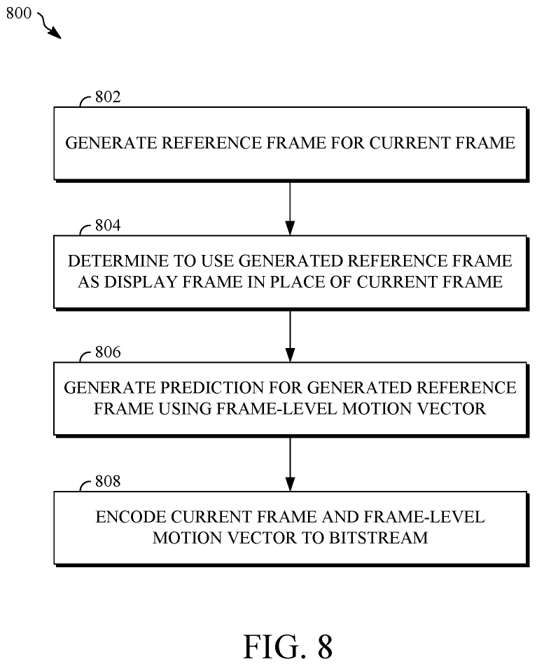

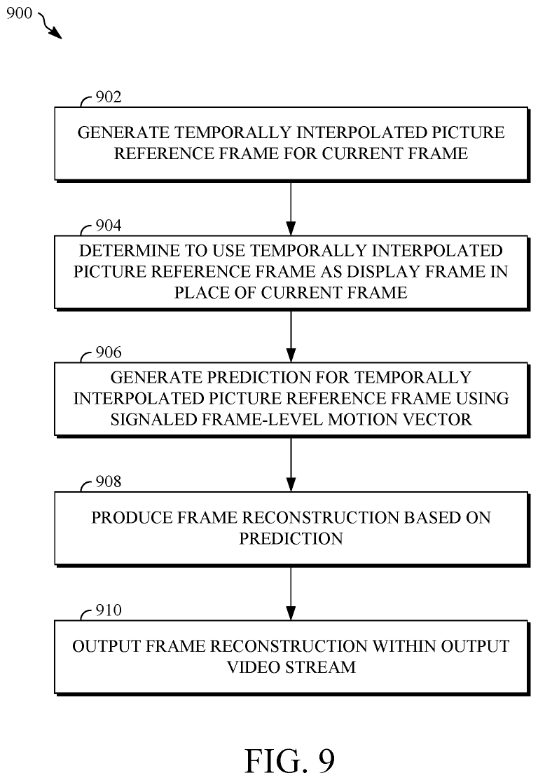

Further details of techniques for temporally interpolated picture prediction using a frame-level motion vector are now described. FIG. 8 is a flowchart diagram of an example of a technique 800 for temporally interpolated picture prediction during encoding using a frame-level motion vector. FIG. 9 is a flowchart diagram of an example of a technique 900 for temporally interpolated picture prediction during decoding using a frame-level motion vector. The technique 800 may, for example, be wholly or partially performed at a prediction stage of an encoder used to encode a video stream (e.g., the intra/inter prediction stage 402), while the technique 900 may, for example, be wholly or partially performed at a prediction stage of a decoder used to decode a bitstream (e.g., the intra/inter prediction stage 508).

The technique 800 and/or the technique 900 can be implemented, for example, as a software program that may be executed by computing devices such as the transmitting station 102 or the receiving station 106. For example, the software program can include machine-readable instructions that may be stored in a memory such as the memory 204 or the secondary storage 214, and that, when executed by a processor, such as the processor 202, may cause the computing device to perform the technique 800 and/or the technique 900. The technique 800 and/or the technique 900 can be implemented using specialized hardware or firmware. For example, a hardware component, such as a hardware coder, may be configured to perform the technique 800 and/or the technique 900. As explained above, some computing devices may have multiple memories or processors, and the operations described in the technique 800 and/or the technique 900 can be distributed using multiple processors, memories, or both. For simplicity of explanation, the technique 800 and the technique 900 are each depicted and described herein as a series of steps or operations. However, the steps or operations in accordance with this disclosure can occur in various orders and/or concurrently. Additionally, other steps or operations not presented and described herein may be used. Furthermore, not all illustrated steps or operations may be required to implement a technique in accordance with the disclosed subject matter.

Referring first to FIG. 8, the technique 800 for temporally interpolated picture prediction during encoding using a frame-level motion vector is shown. At 802, a reference frame is generated for a current frame to encode (e.g., from an input video stream) using a backward reference frame of the current frame and a forward reference frame of the current frame. For example, the generated reference frame may be a TIP reference frame. Generating the reference frame using the backward reference frame and the forward reference frame can include using motion vectors of the backward reference frame and of the forward reference frame to generate a motion field for the current frame and using the motion field to fetch, from those reference frames, reference blocks usable (e.g., via interpolation) to generate the reference frame.

At 804, a determination is made to use the generated reference frame as a display frame in place of the current frame. Determining to use the generated reference frame during an encoding of the current frame can include using encoder motion search data to determine whether there is a motion mismatch with respect to the generated reference frame and a ZEROMV motion vector determined for the generated reference frame.

At 806, based on the determination to use the generated reference frame as a display frame, a prediction is generated for the generated reference frame using a frame-level motion vector. The frame-level motion vector may, for example, be the ZEROMV motion vector. The frame-level motion vector is applied against the entire generated reference frame using motion compensation to generate the prediction for the generated reference frame.

At 808, the prediction and the frame-level motion vector are encoded to a bitstream. For example, the frame-level motion vector may be signaled in connection with a frame header associated with the prediction.

Referring next to FIG. 9, the technique 900 for temporally interpolated picture prediction during decoding using a frame-level motion vector is shown. At 902, a reference frame is generated for a current frame to decode (e.g., from a bitstream) using a backward reference frame of the current frame and a forward reference frame of the current frame. For example, the generated reference frame may be a TIP reference frame. Generating the reference frame using the backward reference frame and the forward reference frame can include using motion vectors of the backward reference frame and of the forward reference frame to generate a motion field for the current frame and using the motion field to fetch, from those reference frames, reference blocks usable (e.g., via interpolation) to generate the reference frame.

At 904, a determination is made to use the generated reference frame as a display frame in place of the current frame. Determining to use the generated reference frame during a decoding of the current frame can include determining whether there is a motion mismatch with respect to the generated reference frame based on a signaling of a ZEROMV motion vector for the generated reference frame. For example, the ZEROMV motion vector may be a frame-level motion vector determined and encoded to the bitstream for use with the generated reference frame.

At 906, based on the determination to use the generated reference frame as a display frame, a prediction is generated for the generated reference frame using a frame-level motion vector signaled within the bitstream from which the current frame is being decoded (e.g., the ZEROMV motion vector used to determine the motion mismatch). Generating the prediction includes performing motion compensation against the generated reference frame using the frame-level motion vector.

At 908, a frame reconstruction is produced based on the prediction. The frame reconstruction represents a final display frame to use for the generated reference frame and thus in place of the current frame. In some implementations, producing the frame reconstruction can include using an interpolation filter to interpolate the motion indicated by the frame-level motion vector. For example, where the motion vector points to a sub-pixel location, an interpolation filter may be used to determine how to interpolate that motion between the two or more subject pixels. The particular interpolation filter to use may be determined based on bitstream data signaled according to encoder search data (e.g., indicating the interpolation filter that results in minimal distortion against the current frame in its pre-coded form).

At 910, the frame reconstruction is output within an output video stream. For example, the frame reconstruction may be output for display during playback of the output video stream at a computing device.

The aspects of encoding and decoding described above illustrate some examples of encoding and decoding techniques. However, it is to be understood that encoding and decoding, as those terms are used in the claims, could mean compression, decompression, transformation, or any other processing or change of data.

The word “example” is used herein to mean serving as an example, instance, or illustration. Any aspect or design described herein as “example” is not necessarily to be construed as being preferred or advantageous over other aspects or designs. Rather, use of the word “example” is intended to present concepts in a concrete fashion. As used in this application, the term “or” is intended to mean an inclusive “or” rather than an exclusive “or.” That is, unless specified otherwise or clearly indicated otherwise by the context, the statement “X includes A or B” is intended to mean any of the natural inclusive permutations thereof. That is, if X includes A; X includes B; or X includes both A and B, then “X includes A or B” is satisfied under any of the foregoing instances. In addition, the articles “a” and “an” as used in this application and the appended claims should generally be construed to mean “one or more,” unless specified otherwise or clearly indicated by the context to be directed to a singular form. Moreover, use of the term “an implementation” or the term “one implementation” throughout this disclosure is not intended to mean the same implementation unless described as such.

Implementations of the transmitting station 102 and/or the receiving station 106 (and the algorithms, methods, instructions, etc., stored thereon and/or executed thereby, including by the encoder 400 and the decoder 500, or another encoder or decoder as disclosed herein) can be realized in hardware, software, or any combination thereof. The hardware can include, for example, computers, intellectual property (IP) cores, application-specific integrated circuits (ASICs), programmable logic arrays, optical processors, programmable logic controllers, microcode, microcontrollers, servers, microprocessors, digital signal processors, or any other suitable circuit. In the claims, the term “processor” should be understood as encompassing any of the foregoing hardware, either singly or in combination. The terms “signal” and “data” are used interchangeably. Further, portions of the transmitting station 102 and the receiving station 106 do not necessarily have to be implemented in the same manner.

Further, in one aspect, for example, the transmitting station 102 or the receiving station 106 can be implemented using a general purpose computer or general purpose processor with a computer program that, when executed, carries out any of the respective methods, algorithms, and/or instructions described herein. In addition, or alternatively, for example, a special purpose computer/processor can be utilized which can contain other hardware for carrying out any of the methods, algorithms, or instructions described herein.

The transmitting station 102 and the receiving station 106 can, for example, be implemented on computers in a video conferencing system. Alternatively, the transmitting station 102 can be implemented on a server, and the receiving station 106 can be implemented on a device separate from the server, such as a handheld communications device. In this instance, the transmitting station 102 can encode content into an encoded video signal and transmit the encoded video signal to the communications device. In turn, the communications device can then decode the encoded video signal. Alternatively, the communications device can decode content stored locally on the communications device, for example, content that was not transmitted by the transmitting station 102. Other suitable transmitting and receiving implementation schemes are available. For example, the receiving station 106 can be a generally stationary personal computer rather than a portable communications device.

Further, all or a portion of implementations of this disclosure can take the form of a computer program product accessible from, for example, a computer-usable or computer-readable medium. A computer-usable or computer-readable medium can be any device that can, for example, tangibly contain, store, communicate, or transport the program for use by or in connection with any processor. The medium can be, for example, an electronic, magnetic, optical, electromagnetic, or semiconductor device. Other suitable mediums are also available.

The above-described implementations and other aspects have been described in order to facilitate easy understanding of this disclosure and do not limit this disclosure. On the contrary, this disclosure is intended to cover various modifications and equivalent arrangements included within the scope of the appended claims, which scope is to be accorded the broadest interpretation as is permitted under the law so as to encompass all such modifications and equivalent arrangements.

1. A method for prediction using a frame-level motion vector, the method comprising:
generating, for a current frame encoded to a bitstream, a reference frame using a backward reference frame of the current frame and a forward reference frame of the current frame;
determining to use the generated reference frame as a display frame in place of the current frame;
generating, based on the determination, a prediction for the generated reference frame using a frame-level motion vector signaled within the bitstream;
producing a frame reconstruction based on the prediction; and
outputting the frame reconstruction within an output video stream.

2. The method of claim 1, wherein generating the reference frame using the backward reference frame and the forward reference frame comprises:
using motion vectors of the backward reference frame and of the forward reference frame to generate a motion field for the current frame;
using the motion field to fetch reference blocks from the backward reference frame and the forward reference frame; and
generating the reference frame using the reference blocks.

3. The method of claim 2, wherein generating the reference frame using the reference blocks comprises:
interpolating the reference blocks.

4. The method of claim 1, wherein determining to use the generated reference frame as a display frame in place of the current frame comprises:
determining whether there is a motion mismatch with respect to the generated reference frame based on a signaling of a ZEROMV motion vector for the generated reference frame.

5. The method of claim 4, wherein the ZEROMV motion vector is the frame-level motion vector.

6. The method of claim 1, wherein generating the prediction for the generated reference frame using the frame-level motion vector signaled within the bitstream comprises:
performing additional residual coding against the generated reference frame to prepare content of the generated reference for display within the output video stream.

7. The method of claim 6, wherein the additional residual coding includes motion compensation performed against the generated reference frame using the frame-level motion vector.

8. The method of claim 1, wherein producing the frame reconstruction based on the prediction comprises:
using an interpolation filter to interpolate motion indicated by the frame-level motion vector.

9. The method of claim 8, wherein the interpolation filter is based on data signaled within the bitstream according to an encoder search.

10. A non-transitory computer readable medium having stored thereon an encoded bitstream, wherein the encoded bitstream is configured for decoding by operations for prediction using a frame-level motion vector signaled within the encoded bitstream, the operations comprising:
determining to use a generated reference frame associated with a current frame encoded to the encoded bitstream as a display frame in place of the current frame;
generating, based on the determination, a prediction for the generated reference frame using the frame-level motion vector; and
outputting, within an output video stream, a frame reconstruction produced based on the prediction.

11. The non-transitory computer readable medium of claim 10, the operations comprising:
generating the generated reference frame using motion vectors of a backward reference frame of the current frame and of a forward reference frame of the current frame.

12. The non-transitory computer readable medium of claim 10, wherein determining to use the generated reference frame as a display frame in place of the current frame comprises:
determining that the frame-level motion vector is signaled within the encoded bitstream for the generated reference frame.

13. The non-transitory computer readable medium of claims 10, wherein generating the prediction for the generated reference frame using the frame-level motion vector comprises:
performing motion compensation against the generated reference frame using the frame-level motion vector.

14. The non-transitory computer readable medium of claims 10, the operations comprising:
producing the frame reconstruction based on the prediction; and
using an interpolation filter to prepare the frame reconstruction for output as a final display frame by interpolating motion indicated by the frame-level motion vector.

15. An apparatus for prediction using a frame-level motion vector, the apparatus comprising:
a memory; and
a processor configured to execute instructions stored in the memory to:
generate a reference frame for a current frame to decode;
determine to replace the current frame with the generated reference frame within an output video stream;
generate, based on the determination, a prediction for the generated reference frame using a frame-level motion vector; and
output, as a display frame within the output video stream, a frame reconstruction produced based on the prediction.

16. The apparatus of claim 15, wherein the generated reference frame is generated using a backward reference frame of the current frame and a forward reference frame of the current frame, wherein the backward reference frame, the current frame, and the forward reference frame are signaled within and decoded from an encoded bitstream.

17. The apparatus of claim 16, wherein the determination to replace the current frame with the generated reference frame within the output video stream is based on a signaling of the frame-level motion vector within the encoded bitstream.

18. The apparatus of claim 15, wherein the prediction is generated based on additional residual coding performed against the generated reference frame.

19. The apparatus of claim 18, wherein the additional residual coding includes motion compensation performed using the frame-level motion vector.

20. The apparatus of claim 15, wherein the frame reconstruction is produced using an interpolation filter.
